(19) United States
(12) Patent Application Publication
(10) Pub. No.: US 2023/0305159 A1
(43) Pub. Date: Sep. 28, 2023

(54) APPARATUS FOR TESTING LIDAR MODULES AND TEST METHOD

(71) Applicant: Magna Electronics Europe GmbH & Co. OHG, Sailuaf (DE)

(72) Inventor: Thomas Wierich, Butzbach (DE)

(21) Appl. No.: 18/002,509

(22) PCT Filed: Jul. 15, 2021
(86) PCT No.: PCT/EP2021/069876

§ 371 Date: Dec. 20, 2022

(30) Foreign Application Priority Data
Jul. 20, 2020 (DE) 10 2020 209 029.7

(51) Int. Cl. G01S 17/894; G01S 7/497

(52) U.S. Cl. CPC G01S 17/894; G01S 7/497

(57) ABSTRACT

An apparatus for testing a lidar sensor module includes a camera, at least one laser for generating at least one return pulse on account of test signals from the at least one laser, an optical beam splitter in the beam path between the lidar sensor module and an absorber, wherein the camera is arranged perpendicular to the beam path between the lidar sensor module and the absorber and the camera has an optical distance from an object to be detected that is greater than the optical distance between the lidar sensor module and the object to be detected.

### CROSS-REFERENCE TO RELATED APPLICATIONS

This application is a National Stage of International Application No. PCT/EP2021/069876, filed Jul. 15, 2021, which claims priority to DE 102020209029.7 filed Jul. 20, 2020. The entire disclosures of each of the above applications are incorporated herein by reference.

### FIELD OF THE INVENTION

The invention relates to an apparatus for testing lidar modules and a method for testing lidar modules.

### BACKGROUND OF THE INVENTION

This section provides information related to the present disclosure which is not necessarily prior art.

### PRIOR ART

Sensors play an increasingly important role in the automotive industry. The trend is amplified by the goal of moving a vehicle autonomously, which presumes sensors having a high level of reliability and good resolution.

Lidar sensors are granted important significance for autonomous driving. Lidar, thus light detection and ranging, is an optical measuring system for detecting objects. The position of the object to be detected may be determined by the reflection of the emitted light on the object to be detected until the arrival of the scattered light at the receiver via the time of flight of the light signals.

Presently, lidar sensors are used for the purpose of developing systems for autonomous vehicles which can also drive in public road traffic. Lidar sensors supplement the sensors of conventional assistance systems, such as ultrasonic or radar sensors in the vehicle.

In LIDAR, the surroundings are illuminated line by line using a light spot from a pulsed laser light source. A contour of the surroundings is determined from the amplitude or intensity of the reflected and backscattered light. Furthermore, the distance to objects is determined from the time of flight of the light pulses, so that overall a three-dimensional depiction of the surroundings can be created, which can be assessed in image processing software. The line by line scanning has to take place fast enough that a reaction time suitable for driving operation is implementable.

Either LEDs or laser diodes are used as the emitting unit. They have the advantage of being able to be modulated quickly. Pulses can thus be generated fast with respect to time, which are important for the time of flight measurement. For this purpose, a light pulse is emitted in a few nanoseconds in the wavelength range of the near infrared. Depending on the lidar sensor type, this wavelength is between 840 and 950 nm. The receiver consists of multiple segments and each segment receives a separate emitted pulse. Due to the complex structure of the receiver, each pixel measures the time of flight of the emitted pulse intended for it from the incident light. The emitted pulse is reflected from the object to be measured and recognized by the receiver.

A lidar sensor is known from DE 10 2008 055 159 A1, in which the detection field is predefinable in the vertical and horizontal directions by an adjustment of the oscillation amplitude of the micromechanical mirror. In LIDAR, the surroundings are illuminated line by line using a light spot from a pulsed laser light source. The laser beam is deflected here by a micromirror, which oscillates, for example, in the horizontal direction at 24 kHz and in the vertical direction at 60 Hz, so that 60 images of the surroundings per second are generated. The mirror oscillates according to the prior art in both directions at constant amplitude in each case, so that fixed angle ranges are scanned.

In the production of the lidar sensors, the final quality test is of great importance. Each individual lidar sensor has to be tested in this case, which of course has to take place quickly and with the least possible effort in series production.

### SUMMARY OF THE INVENTION

This section provides a general summary of the disclosure, and is not a comprehensive disclosure of its full scope or all of its features.

It is the object of the invention to provide an apparatus and a method for testing lidar modules, which measure important parameters of the lidar sensors simultaneously in an uncomplicated manner.

The object is achieved by an apparatus for testing lidar sensor modules comprising a camera, lasers for generating at least one return pulse due to test signals of the lasers, an optical beam splitter in the beam path between the lidar sensor module and an absorber, wherein the camera is arranged perpendicularly to the beam path between lidar sensor module and absorber and the camera has an optical distance to an object to be detected which is greater than the optical distance between lidar sensor module and object to be detected.

The apparatus has the advantage of being very compact and nonetheless having a significant test range to be able to measure the desired parameters for the lidar sensor module.

It is particularly advantageous if the optical distance to an object to be detected is twice the optical distance between lidar sensor module and object to be detected.

The test signals of the lasers generate a uniformly diffuse illumination and/or an illumination structured using a pattern.

It is advantageous here that the beam splitter splits the output signals of the lidar sensor module, the test signals of the lasers, and also the return signals from the object to be detected.

In one advantageous embodiment, one side of the beam splitter is reflective 1%, and the other side is reflective 0.25% for the incident light.

It is advantageous that the apparatus has a climatically controlled chamber for accommodating the lidar sensor module to be tested, which is separated from a test chamber.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows the optical signal path of a lidar module,

FIG. 2 shows a structure of a test apparatus.

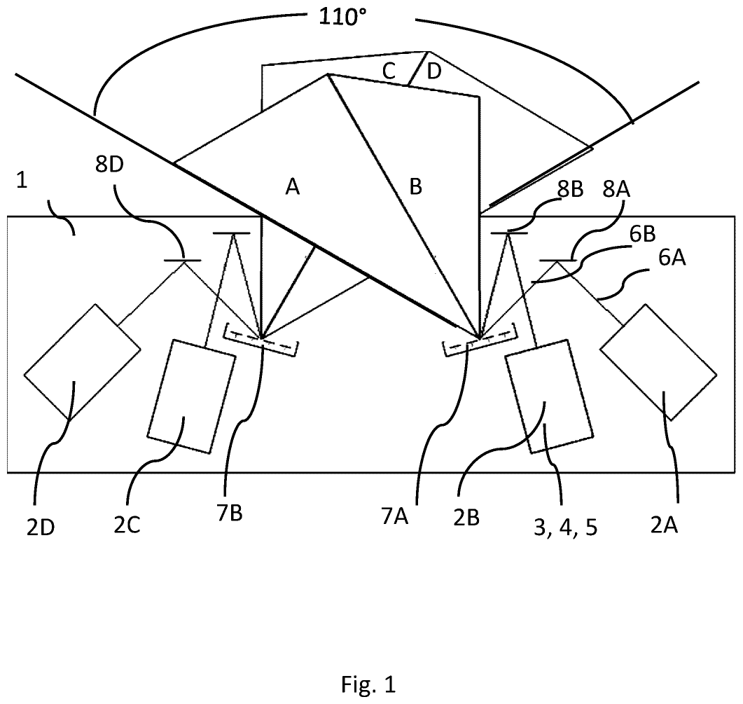

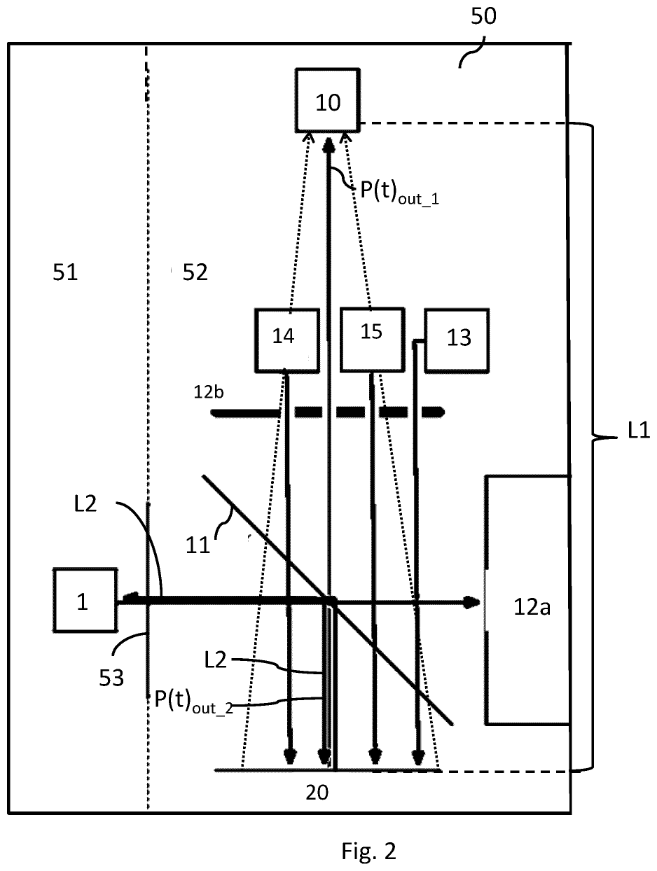

FIG. 1 shows the optical signal path of an exemplary lidar module 1, which is constructed from multiple lidar sensor segments 2A, 2B, 2C, 2D.

### DESCRIPTION OF THE INVENTION

Each of the lidar sensor segments 2A, 2B, 2C, 2D comprises a laser, a short-range detector 3, for example implemented using an avalanche photodiode, and a long-range detector 4, for example a photomultiplier 5. Each photomultiplier 5 is constructed in this example from eight individual detector segments, to capture incoming scattered signals spatially separate from one another and pass them on for processing. The electric and electronic activation of the lasers and the connection of the receiver components, consisting of avalanche photodiodes and photomultipliers, to the evaluating controllers are not shown in more detail.

On a transmission path 6A, light from the laser of the lidar sensor segment 2A goes through an optical unit (not shown in greater detail) to a mirror 8A and with the light path 6B on a deflection unit 7A consisting of MEMS. MEMS, micro-electro-mechanical systems, are miniature components which unify logic elements and micromechanical structures in one chip. They can process items of mechanical and electrical information and have small mirrors for the deflection of the laser light. A zone A is then illuminated using the laser light pulse by pulse by one of the mirrors of the deflection unit 7A.

Similarly thereto, the further lidar sensor segments 2B, 2C, 2D emit laser light onto the assigned mirrors 8B, 8C, 8D and the assigned deflection units 7A, 7B.

The receiving path of the lidar sensor module corresponds to the inverse emitting path. The light scattered on the detected object of a specific laser pulse is incident on the associated deflection unit 7A, 7B, the MEMS, and enters through the optical unit (not shown) of the lidar sensor segment 2A, 2B, 2C, 2D and is incident on respectively the short-range detector 3 and the respective long-range detectors 4.

In the embodiment of the lidar sensor module 1 selected as an example, the nominal optical resolution is 0.1° by 0.1°. The lidar sensor module 1 is defined for norm al operation having a measuring range M to be scanned of approximately 120° horizontal×16° vertical. A measurement in 1200×160 channels results therefrom at the resolution.

To test individual lidar sensor modules 1 for their quality, the lidar sensor modules 1 have to be subjected to a final function test.

The structural design of the lidar sensor module 1 results in five different groups of parameters for the lidar sensor module 1, which have to be detected by a test. These parameters completely characterize an individual lidar sensor module 1 in relation to other individuals of the same lidar sensor module basic design.

All parameters are measured here in a black box test, since only input and output of the lidar sensor module 1 have to be provided. The test module is therefore only concerned with the emitted light of the lidar module being recorded and then a return being generated on a path which simulates a reflected signal to the receiving path of the lidar module.

Parameter 1: A first parameter P(t)ₒᵤₜ relates to the emitted laser signal having its externally observable properties. For the emitted laser signal of each of the provided lasers, the angle distribution of the emitted laser pulses is measured over a predetermined measuring range M in a frame and the defined scanning range (deflection of the mirror) three-dimensionally plus a boundary range of the scanning using a scanning pattern. So as not to have to calibrate, the scanning range is dimensioned somewhat more generously. Lidar sensors deflect the laser beam in various directions over the scene to detect their surroundings. Unique patterns thus result in the point cloud, which are referred to as scanning patterns. The pattern is actuated by the MEMS, which deflect the laser beam by the mirror movements. By measuring the integral of the intensity for all individual laser pulses within a timeframe, the total energy P(t)ₒᵤₜ of the laser signal is determined, wherein the measurement takes place over the measuring range M. The light power is integrated over the time of a frame for all laser pulses.

Moreover, the three-dimensional shape of each individual laser pulse in the measuring range M is determined for the distribution of the energy. In other words, the shape of the pulse is measured.

As a second parameter P2, the response behavior of the lidar sensor module with respect to incident light P(t)ᵢₙ from an external source is determined and the absolute sensitivity is determined over the measuring range M both for close range and also for long range.

Furthermore, as a third parameter P3, the angle coupling of emitting and receiving path has to be measured over the measuring range M. Each point on the camera is assigned to a point. The laser 15 is pulsed and emits light through a perforated mask, an image is thus generated in the camera and the angle relationship can be assessed therein. The optical path can thus be measured and a misalignment of the lidar module can be established if a software test has taken place.

The fourth parameter P4 is the angle resolution in the camera 10 over the measuring range M.

The fifth parameter P5 determines the influence of the background illumination, the main source of which in the application is the sun. A disturbance variable is generated, which decisively determines the signal-to-noise ratio at the lidar module. This signal-to-noise ratio defines a false alarm rate. The higher the threshold of the signal-to-noise ratio, the later an alarm is generated, wherein the distance sensitivity is reduced, however.

A test apparatus 50 is used for testing, which accommodates the test object, the lidar module 1, in a climatically controlled chamber 51. The chamber 51 has a window 53, via which the lidar sensor module 1 is optically connected to the actual test chamber 52. The test chamber is filled using a dry gas to maintain defined test conditions.

To carry out the measurements, the emission power P(t)ₒᵤₜ of the lidar sensor module 1 is detected by a camera 10 in the test chamber 52. For this purpose, the laser signal is split at a beam splitter 11 in three directions. The linearly continuous beam is absorbed in an absorber 12a. A part of the laser power P(t)ₒᵤₜ_1 is imaged on the camera 10, a further part P(t)ₒᵤₜ_2 is incident on the object 20 to be detected.

The horizontal resolution of the camera 10 is, for example, 4K.

To enable a reasonable measuring range for the camera 10, the distance L1 to the object 20 to be detected has to be greater than the distance L2 of the lidar sensor module 1 to the object 20 to be detected, which extends with a direction change at the beam splitter 11. The distance L2 is a combination of the distance of the lidar sensor module to the beam splitter 11 and of the distance from the beam splitter 11 to the object 20. If one selects twice the distance L1 in relation to L2, the measuring range of the camera 10 is limited to approximately 60°.

The received signal P(t)ᵢₙ is simulated in that a laser pulse is used which is triggered by the emitted pulse P(t)ₒᵤₜ.

The apparatus for testing has to measure all required parameters at various temperatures and supply voltages.

For this purpose, it is indispensable to keep the volume and the mass which has to be thermally controlled minimal, which is achieved in that the lidar module 1 is held separately and the test chamber 52 does not have to be opened.

The camera 10 has, for example, a 4K resolution. The region of particular interest, ROI, is limited here to a partial image of 4096×546 pixels.

The camera 10 has to have a global shutter, so that sharp images of rapidly moving objects are possible, since all pixels can be exposed simultaneously. The global shutter is synchronized with the beginning of a data frame, thus with the activation of the lidar sensor module 1. Only one image of the camera 10 is recorded per data frame.

The camera image has to be deconvoluted, thus processed by computer, to remove the double image arising due to the optical beam splitter 11 in the beam path. The camera 10 detects the scanning pattern, the pulse energy, and the pulse shape.

A laser 14, which simulates one of the return signals, illuminates the object 20 to be detected diffusely and uniformly using light in order to generate a constant response pulse of the object to be detected. The illumination of the measuring range is then measured, which is to be as homogeneous as possible.

The laser 14 operates with a variable delay between the emitted pulse P(t)ₒᵤₜ_1 of the lidar module 1 to be detected by the camera and the return signal Rₓ from the object 20 to be detected.

Moreover, the laser 14 has to have the capability for the return signal of regulating the energy of the return signal Rₓ. This arrangement tests the sensitivity for return signals Rₓ. A diffuser plate is used, which, when arranged in front of the laser 14, generates evenly diffuse light.

For a measurement having a pattern in the return signal R_{x_patt}, a second laser 15 has to illuminate the object 20 to be detected using three-dimensionally structured illumination pulses for the pattern return signal. The pattern consists, for example, of randomly oriented short bars, a stroke pattern or fish pattern, which is formed as a grating disk to be illuminated through.

Alternatively to the two lasers 14, 15, a single laser can also be used, wherein diffuser disk and grating disk are attached pivotably in the beam direction in front of the laser in an upstream filter changer and are illuminated through alternatively.

It is provided here that the entire object 20 to be detected is illuminated uniformly using the pattern. The second laser 15 generates a point cloud which is detected by the camera.

The laser 15 also requires a variable delay between the emitted signal P(t)ₒᵤₜ detected at the camera 10 and the return signal R_{x_patt}.

Moreover, the laser 15 has to have the capability for the return signal R_{x_patt} of generating the energy of the return signal by regulating the test signal.

The arrangement tests the alignment of emitted signal to return signal and the resolution.

The optical splitter 11 consists of a glass plate having coating on both sides. For the infrared range at 905 nm range, coatings are easily available. The two sides have to have a different reflectivity having a ratio of greater than 2:1. One exemplary embodiment is selected so that one side reflects 1% and the other side reflects 0.25% of the incident light.

The absorbers 12a and 12b are used for the absorption of light which is not required. The absorber 12a absorbs the emitted pulse of the lidar module and the absorber 12b absorbs the return pulse from the object 20 to be detected.

Infrared LEDs are used for the background illumination 13. They can operate at different luminous intensities and make threshold variables measurable. The luminous intensity is varied to be able to recognize thresholds. The background illumination 13 simulates solar radiation and assumes the function of a disturbance variable.

The camera 10 records a greatly reduced light signal from the lidar module 1, which is branched off by the optical splitter 11. The camera records the scanning pattern image frame by image frame. The lidar module and the test modules operate at an image frequency of 15 Hz.

The camera 10 provides a trigger signal to trigger the signals of the lasers 14 and 15 and generate a simulated response signal.

The grating disk generates a corresponding input signal in the camera 10. The point cloud generated by the grating disk and the laser 15 is recorded at the lidar module 1, the camera image is transferred to a test controller outside the tester.

The tester is only an optoelectronic head, which generates light and records light in a camera.

1. An apparatus for testing a lidar sensor module, the apparatus comprising:
a camera,
at least one laser for generating at least one return pulse on the basis of test signals of the at least one laser,
an optical beam splitter in the beam path between the lidar sensor module and an absorber, and
wherein the camera is arranged perpendicularly to the beam path between the lidar sensor module and the absorber and the camera has an optical distance to an object to be detected which is greater than the optical distance between the lidar sensor module and the object to be detected.

2. The apparatus for testing as claimed in claim 1, characterized in that the optical distance to an object to be detected is twice the optical distance between the lidar sensor module and the object to be detected.

3. The apparatus for testing as claimed in claim 1, characterized in that the test signals of the at least one laser generate a uniformly diffuse illumination.

4. The apparatus for testing as claimed in claim 1, characterized in that the test signals of the at least one laser generate an illumination structured using a pattern.

5. The apparatus for testing as claimed in claim 1, characterized in that the beam splitter splits the output signals (Pₒᵤₜ) of the lidar sensor module, the test signals of the lasers, and also the return signals from the object to be detected.

6. The apparatus for testing as claimed in claim 1, characterized in that one side of the beam splitter reflects 1% and the other side of the beam splitter reflects 0.25% of the incident light.

7. The apparatus for testing as claimed in claim 3, characterized in that a single laser having an upstream filter changer generates both diffuse light and also an illumination structured using a pattern.

8. The apparatus for testing as claimed in claim 1, characterized in that a background illumination having LEDs is used, which operate at different luminous intensities and is used as a disturbance variable of the measurement.

9. The apparatus for testing as claimed in claim 1, characterized in that the apparatus has a climatically controlled chamber for accommodating the lidar sensor module to be tested, which is separated from a test chamber.

10. The apparatus as claimed in claim 9, characterized in that the test chamber is filled using a dry gas.
